(19) United States
(12) Patent Application Publication
(10) Pub. No.: US 2017/0273155 A1
(43) Pub. Date: Sep. 21, 2017

(54) APPARATUS FOR CONTROLLING LIGHT EMITTING DIODE MODULE HAVING LIGHT INTENSITY COMPENSATION FUNCTION AND LIGHTING SYSTEM INCLUDING THE SAME

(71) Applicant: UVER CORPORATION LTD., Ansan-si (KR)

(72) Inventor: Yong Hoon KANG, Suwon-si (KR)

(21) Appl. No.: 15/228,180

(22) Filed: Aug. 4, 2016

(30) Foreign Application Priority Data
Mar. 21, 2016 (KR) 10-2016-0033439

(51) Int. Cl. H05B 33/08

(52) U.S. Cl. CPC H05B 33/0851; H05B 33/089; H05B 33/0815

(57) ABSTRACT

An apparatus for controlling a light emitting diode (LED) module having a light intensity compensation function includes a light intensity sensor measuring intensity of light irradiated by the LED module depending on a current value, based on a predetermined light intensity signal; a compensation signal generating unit generating a compensated light intensity signal to compensate for an error between measured light intensity and predetermined light intensity; and a pulse width modulation signal generating unit allowing the LED module to irradiate light having uniform brightness in such a manner that a pulse width modulation signal depending on the compensated light intensity signal is applied to an LED driver, in an apparatus for controlling LED lighting including an LED driver.

### CROSS-REFERENCE TO RELATED APPLICATION

This application claims the benefit of priority to Korean Patent Application No. 10-2016-0033439, filed on Mar. 21, 2016 with the Korean Intellectual Property Office, the entirety of which is incorporated herein by reference.

### BACKGROUND

The present disclosure relates to an apparatus for controlling a light emitting diode (LED) module having a light intensity compensation function and a lighting system including the same.

LEDs used for displays, landscape lighting, and the like, are optical semiconductor devices emitting light through an electric current being applied to a semiconductor device, such as an ultraviolet (UV) LED. In this regard, LEDs are devices emitting light using a semiconductor having a p-n junction structure, in such a manner that when a positive voltage is applied to a p-type semiconductor portion to extract an electron, a hole is formed, and when a ‘negative voltage’ is applied to an n-type semiconductor portion to inject electrons, the electrons diffuse, to be recombined with holes at an interface, and light is emitted.

Since such LEDs have a significant energy saving effect, compared with conventional light sources, such as a general lamp, or the like, and may be used semi-permanently, LEDs have been recognized as next-generation light sources. As the market for LEDs expands across various industries, the era of mass-utilization of LEDs has arrived.

Control of LEDs is generally classified into voltage control and electric current control methods. Voltage control is the method of applying a predetermined voltage to an LED module, while electric current control is the method of applying a predetermined electric current to an LED module.

Semiconductors begin to dissipate heat due to internal resistance when an electric current flows in the state of conductivity. The higher the level of an electric current, the more heat is dissipated. In addition, proportionally to a heating value, a level of internal resistance is reduced. According to Ohm's law, when a voltage is fixed, and a level of resistance is reduced, a level of electric current is increased. To the point of a state of thermal equilibrium, the level of resistance continues to be reduced, and the level of an electric current continues to be increased. Therefore, a voltage control method is not able to limit a current, and is thus not able to prevent damage to a light emitting diode (LED) device caused by heat.

On the other hand, an electric current control method is able to limit the level of such an electric current, thus preventing loss of the LED device caused by heat. However, the electric current control method also has a problem in which the loss of light intensity caused by heat of the LED device is inevitable.

### SUMMARY

An aspect of the present disclosure provides an apparatus for controlling a light emitting diode (LED) module having a light intensity compensation function and a lighting system including the same, reducing loss of light intensity of a light emitting diode (LED) device caused by heat to allow an LED module to irradiate light having uniform brightness continually.

According to an aspect of the present disclosure, an apparatus for controlling an LED module includes a light intensity sensor measuring light intensity of light irradiated by the LED module depending on a current value, based on a predetermined light intensity signal; a compensation signal generating unit generating a compensated light intensity signal to compensate for an error between measured light intensity and predetermined light intensity; and a pulse width modulation signal generating unit allowing the LED module to irradiate light having uniform brightness in such a manner that a pulse width modulation signal depending on the compensated light intensity signal is applied to an LED driver, in an apparatus for controlling LED lighting including an LED driver.

According to another aspect of the present disclosure, a lighting system includes an LED module; an alternating current-to-direct current (AC/DC) converter converting input AC power into DC power; an LED driver receiving converted DC power to control the LED module; and an apparatus for controlling an LED module controlling the LED driver to allow the LED module to irradiate light having uniform brightness.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a block diagram of an apparatus for controlling a light emitting diode (LED) module having a light intensity compensation function and a lighting system including the same according to an exemplary embodiment;

FIG. 2 is a waveform diagram of a main component of an apparatus for controlling an LED module according to an exemplary embodiment;

FIG. 3 is a circuit diagram of a light intensity sensor according to an exemplary embodiment;

FIG. 4 is a diagram of a temperature measuring sensor according to an exemplary embodiment; and

FIG. 5 is a flow chart illustrating a method of compensating light intensity according to an exemplary embodiment.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no other elements or layers intervening therebetween.

Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship relative to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

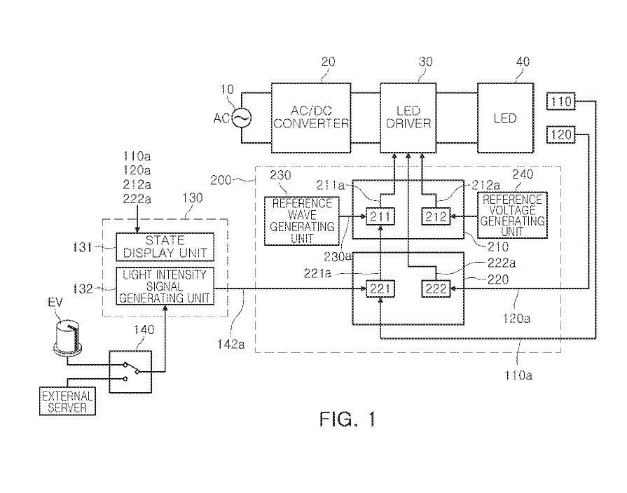

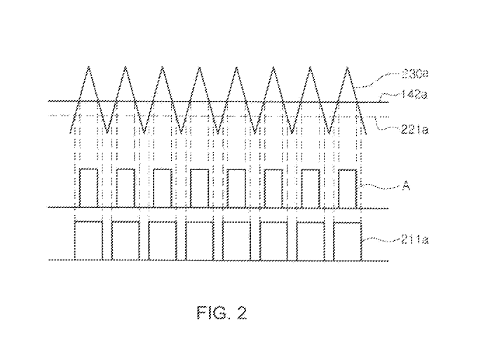

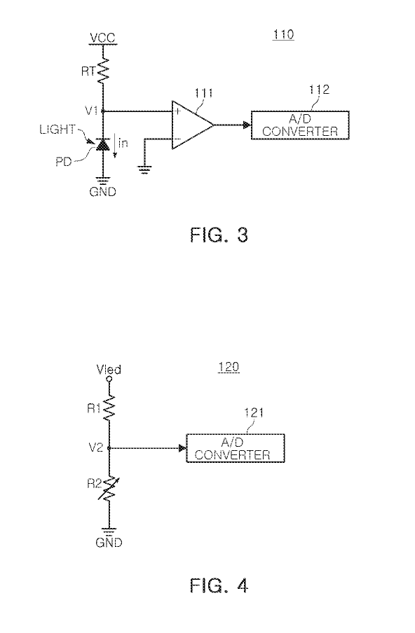

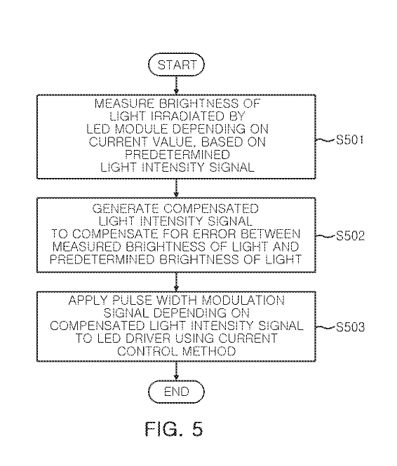

FIG. 1 is a block diagram of an apparatus for controlling a light emitting diode (LED) module having a light intensity compensation function and a lighting system including the same according to an exemplary embodiment. FIG. 2 is a waveform diagram of a main component of an apparatus for controlling an LED module according to an exemplary embodiment. In addition, FIG. 3 is a circuit diagram of a light intensity sensor according to an exemplary embodiment, while FIG. 4 is a diagram of a temperature measuring sensor according to an exemplary embodiment.

First, as illustrated in FIG. 1, a lighting system includes an alternating current-to-direct current (AC/DC) converter 20 converting an AC power 10 into DC power, an LED driver 30 receiving the DC power converted by the AC/DC converter 20 to control the LED module 40, and an apparatus for controlling an LED module controlling the LED driver 30 to allow the LED module 40 to irradiate light having uniform brightness. The LED driver 30 described above may use a pulse width modulation (PWM) method to control an electric current of the LED module 40, and for example, may be provided as a device including a DC/DC converter. In addition, the LED module 40 may include a plurality of LED devices connected in series.

In the meantime, the apparatus for controlling an LED module may include a light intensity sensor 110, a temperature measuring sensor 120, a main control unit 200, an operation panel 130, and a converting switch 140. In addition, the main control unit 200 may include a first module 210 including a pulse width modulation signal generating unit 211 and an output detection operation unit 212, a second module 220 including a compensation signal generating unit 221 and a temperature detection operation unit 222, a reference wave generating unit 230, and a reference voltage generating unit 240.

Hereinafter, a detailed description of a specific composition of the apparatus for controlling an LED module will be provided.

First of all, the light intensity sensor 110 may measure light intensity of the LED module 40. A measured light intensity 110a measured by the light intensity sensor 110 may be transferred to the compensation signal generating unit 221.

In detail, as illustrated in FIG. 3, in a circuit of the light intensity sensor 110, an anode of a photodiode PD may be connected to a ground terminal GND, while a cathode may be connected to a reference voltage VCC through transimpedance resistance RT.

When light is irradiated from an external source, a converted voltage V1 is generated by an electric current lin flowing from the reference voltage VCC to the photodiode PD. Furthermore, the generated converted voltage V1 may be amplified through an amplifier 111 to be converted into a digital value by an analog-to-digital (A/D) converter 112. The circuit of the light intensity sensor 110 described above is only an example, and it will be apparent to those skilled in the art that various other types of circuits to measure light intensity may be applied.

The temperature measuring sensor 120 may measure a temperature of the LED module 40. The temperature of the LED module 40 measured by the temperature measuring sensor 120 may be transferred to the temperature detection operation unit 222.

In detail, as illustrated in FIG. 4, a circuit of the temperature measuring sensor 120 includes fixed resistance R1 connected to power Vled and resistance R2 connected to the fixed resistance R1 in series. In this case, the power Vled is provided as an output voltage of the LED driver 30, while the resistance R1 is provided as a resistance value of the LED device in the LED module 40. The LED device was recorded as a variable resistor in consideration of characteristics of being variable depending on a temperature. A resistance value of the resistance R2 is variable depending on a change in temperature of the LED module 40, while a voltage V2 according to the resistance value of the variable resistance R2 may be converted into the digital value by an A/D converter 121. The circuit of the temperature measuring sensor 120 described above is only an example, and it will be apparent to those skilled in the art that various other types of circuits to measure light intensity may be applied.

The main control unit 200 may control the LED driver 30 to allow the LED module 40 to irradiate light having uniform brightness.

In detail, the compensation signal generating unit 221 may generate a compensated light intensity signal 221a to compensate for an error between the measured light intensity 110a measured by the light intensity sensor 110 and a predetermined light intensity 142a transferred by a light intensity signal generating unit 132. The compensated light intensity signal 221a may be transferred to the pulse width modulation signal generating unit 211.

In this case, the compensated light intensity signal 221a may be generated in a method the same as Formula 1 below.

Vfb_light=Vlight_la−Vlight_st [Formula 1]

In Formula 1, Vfb_light refers to a difference in light intensity, Vlight_la refers to currently measured light intensity, and Vlight_st refers to light intensity measured in a preceding operation.

Vfb_light=Vfb_current+Vfb_light [Formula 2]

In Formula 2, Vfb_light refers to the compensated light intensity signal 221a, Vfb_current refers to the predetermined light intensity 142a sent by the light intensity signal generating unit 132, and Vfb_light refers to the difference in light intensity, calculated in Formula 1 above.

In other words, the compensated light intensity signal 221a may be obtained using a method of adding the difference in light intensity (Vfb_light) to the predetermined light intensity 142a sent by the light intensity signal generating unit 132. The method described above is only an example, and it will be apparent that variously modified types of methods may be performed according to need by those skilled in the art.

In the meantime, the temperature detection operation unit 222 may apply an off signal 222a to the LED driver 30 in a case in which a measured temperature 120a measured by the temperature measuring sensor 120 is equal to or higher than a predetermined temperature. Applying the off signal 222a to the LED driver 30 is to determine a state of the LED module 40 based on the temperature, and to protect the LED module 40 in such a manner that output of the LED driver 30 is stopped in a case in which the LED module 40 is overheated. For example, the off signal 222a may be provided as a logic high H signal or a low L signal, but is not limited thereto.

The pulse width modulation signal generating unit 211 may apply a pulse width modulation signal 211a depending on the compensated light intensity signal 221a to the LED driver 30, thus allowing the LED module 40 to irradiate light having uniform brightness. The pulse width modulation signal generating unit 211 may be provided as a comparator.

In detail, the reference wave generating unit 230 may generate a reference wave (for example, a triangular wave, a sawtooth wave, or the like) having a predetermined frequency. In addition, the pulse width modulation signal generating unit 211 may generate the pulse width modulation signal 211a in such a manner that a reference wave 230a provided by the reference wave generating unit 230 is compared with the compensated light intensity signal 221a, and may apply the generated pulse width modulation signal 211a to the LED driver 30.

FIG. 2 illustrates a waveform diagram of a main component of an apparatus for controlling an LED module according to an exemplary embodiment.

In detail, as illustrated in FIG. 2, before the apparatus for controlling the LED module 40 is operated, the predetermined light intensity 142a is compared with the reference wave 230a provided by the reference wave generating unit 230, and a pulse width modulation signal A is input into the LED driver 30.

Subsequently, in a case in which the apparatus for controlling the LED module 40 is operated, the compensated light intensity signal 221a compensating the predetermined light intensity 142a is compared with the reference wave 230a based on the measured light intensity 110a measured by the light intensity sensor 110, and thus a new pulse width modulation signal 211a is input into the LED driver 30 to allow the LED module 40 to irradiate light having uniform brightness.

In the meantime, the output detection operation unit 212 may apply the off signal 212a to the LED driver 30 in a case in which an output detection signal transferred by the LED driver 30 is lower than a predetermined reference voltage provided by the reference voltage generating unit 240. The output detection operation unit 212 may be provided as the comparator. For example, the off signal 212a may be provided as the logic high H signal or the low L signal, but is not limited thereto.

In other words, in a case in which an output voltage output by the LED driver 30 is normal, a specific voltage level or higher is maintained. However, in a case in which the LED driver 30 malfunctions or breaks down, the output voltage drops to a specific level or lower. Therefore, in this case, the off signal is applied to the LED driver 30, thus stopping an operation of the LED driver 30. The output detection signal described above may be provided by the LED driver 30, or may be provided in such a manner that the output voltage of the LED driver 30 is directly detected.

In the meantime, the operation panel 130 may include a state display unit 131 and the light intensity signal generating unit 132. In addition, the state display unit 131 may display a state of each unit of the apparatus for controlling an LED module, such as the measured light intensity 110a, the measured temperature 120a, off signals 212a and 222a, and the like.

Furthermore, the light intensity signal generating unit 132 may convert a signal input through an encoder volume (EV) included in the apparatus for controlling the LED module 40 into a light intensity signal to apply to the compensation signal generating unit 221. Alternatively, the light intensity signal generating unit 132 may receive the light intensity signal from an external server to apply to the compensation signal generating unit 221. In addition, the light intensity signal generating unit 132 may further include the converting switch 140 to select one of the EV and the external server.

As described above, according to an exemplary embodiment, a pulse width modulation signal is applied to an LED driver to measure intensity of light irradiated by the LED module and compensate for the error between measured light intensity and predetermined light intensity, thus reducing loss of light intensity of the LED device due to heat to allow the LED module to irradiate light having uniform brightness.

FIG. 5 is a flow chart illustrating a method of compensating light intensity according to an exemplary embodiment.

Hereinafter, with reference to FIGS. 1 to 5, a detailed description of a method of compensating light intensity according to an exemplary embodiment will be provided. However, in order to simplify the present disclosure, a description overlapping the details described in FIGS. 1 to 4 will be omitted.

First, a light intensity sensor 110 may measure brightness of light (light intensity) irradiated by an LED module 40 depending on a current value, based on a predetermined light intensity signal in S501. A measured light intensity 110a measured by the light intensity sensor 110 may be transferred to a compensation signal generating unit 221.

Subsequently, the compensation signal generating unit 221 may generate a compensated light intensity signal 221a to compensate for an error between the measured light intensity 110a measured by the light intensity sensor 110 and a predetermined light intensity 142a transferred by a light intensity signal generating unit 132. The compensated light intensity signal 221a may be transferred to the pulse width modulation signal generating unit 211.

Finally, the pulse width modulation signal generating unit 211 may apply a pulse width modulation signal 211a depending on the compensated light intensity signal 221a to the LED driver 30, thus allowing the LED module 40 to irradiate light having uniform brightness.

As set forth above, according to exemplary embodiments, the present disclosure may measure intensity of light irradiated by an LED module, and may apply a pulse width modulation signal to an LED driver to compensate for an error between measured light intensity and predetermined light intensity, thus reducing loss of light intensity of an LED device due to heat to allow the LED module to irradiate light having uniform brightness.

In addition, in describing the present disclosure, ‘unit’ may be provided using various methods, such as a processor, program instructions executed by the processor, a software module, microcode, a computer program product, a logic circuit, an integrated circuit for an application, firmware, and the like.

While exemplary embodiments have been shown and described above, it will be apparent to those skilled in the art that modifications and variations could be made without departing from the scope of the present invention as defined by the appended claims.

What is claimed is:

1. An apparatus for controlling a light emitting diode (LED) module, comprising:
a light intensity sensor measuring light intensity of light irradiated by the LED module depending on a current value, based on a predetermined light intensity signal;
a compensation signal generating unit generating a compensated light intensity signal to compensate for an error between measured light intensity and predetermined light intensity; and
a pulse width modulation signal generating unit allowing the LED module to irradiate light having uniform brightness in such a manner that a pulse width modulation signal depending on the compensated light intensity signal is applied to an LED driver, in an apparatus for controlling LED lighting including an LED driver.

2. The apparatus for controlling an LED module of claim 1, wherein the compensation signal generating unit adds an error between currently measured light intensity and light intensity measured in a preceding operation to the predetermined light intensity, thus generating the compensated light intensity signal.

3. The apparatus for controlling an LED module of claim 1, wherein the pulse width modulation signal generating unit comprises a comparator generating the pulse width modulation signal in such a manner that a reference wave having a predetermined frequency is compared with the compensated light intensity signal.

4. The apparatus for controlling an LED module of claim 1, wherein the apparatus for controlling LED lighting further comprises a temperature measuring sensor to measure a temperature of the LED module; and a temperature detection operation unit applying an off signal to the LED driver in a case in which a measured temperature is equal to or higher than a predetermined temperature.

5. The apparatus for controlling an LED module of claim 1, wherein the apparatus for controlling LED lighting further comprises an output detection operation unit applying the off signal to the LED driver in a case in which an output detection signal transferred by the LED driver is lower than a predetermined reference voltage.

6. The apparatus for controlling an LED module of claim 1, wherein the apparatus for controlling an LED module further comprises a converting switch to receive the predetermined light intensity signal from one of an encoder volume (EV) and an external server.

7. A lighting system, comprising:
an LED module;
an alternating current-to-direct current (AC/DC) converter converting input AC power into DC power;
an LED driver receiving converted DC power to control the LED module; and
an apparatus for controlling an LED module controlling the LED driver to allow the LED module to irradiate light having uniform brightness.

8. The lighting system of claim 7, wherein the apparatus for controlling an LED module comprises a light intensity sensor measuring light intensity of light irradiated by the LED module depending on a current value, based on a predetermined light intensity signal; a compensation signal generating unit generating a compensated light intensity signal to compensate for an error between measured light intensity and predetermined light intensity; and a pulse width modulation signal generating unit allowing the LED module to irradiate light having uniform brightness in such a manner that a pulse width modulation signal depending on the compensated light intensity signal is applied to the LED driver.

9. The lighting system of claim 8, wherein the compensation signal generating unit adds an error between currently measured light intensity and light intensity measured in a preceding operation to the predetermined light intensity, thus generating the compensated light intensity signal.

10. The lighting system of claim 8, wherein the pulse width modulation signal generating unit comprises a comparator generating the pulse width modulation signal in such a manner that a reference wave having a predetermined frequency is compared with the compensated light intensity signal.

11. The lighting system of claim 8, wherein the apparatus for controlling LED lighting further comprises a temperature measuring sensor to measure a temperature of the LED module; and a temperature detection operation unit applying an off signal to the LED driver in a case in which a measured temperature is equal to or higher than a predetermined temperature.

12. The lighting system of claim 8, wherein the apparatus for controlling LED lighting further comprises an output detection operation unit applying the off signal to the LED driver in a case in which an output detection signal transferred by the LED driver is lower than a predetermined reference voltage.

13. The lighting system of claim 8, wherein the apparatus for controlling an LED module further comprises a converting switch to receive the predetermined light intensity signal from one of an EV and an external server.
